(19) United States
(12) Patent Application Publication
(10) Pub. No.: US 2020/0096115 A1
(43) Pub. Date: Mar. 26, 2020

(54) Valve

(71) Applicant: CPT GROUP GMBH, Hannover (DE)

(72) Inventor: Rosario BONANNO, Bad Soden (DE)

(21) Appl. No.: 16/471,816

(22) PCT Filed: Dec. 14, 2017
(86) PCT No.: PCT/EP2017/082871

§ 371 Date: Jun. 20, 2019

(30) Foreign Application Priority Data
Dec. 22, 2016 (DE) 10 2016 226 080.4

(51) Int. Cl. F16K 1/44; F16K 31/06; F16K 39/02; F02B 37/16

(52) U.S. Cl. CPC F16K 1/44; F16K 31/0655; F02B 37/16; F16K 39/024; F16K 31/0686

(57) ABSTRACT

A valve having a housing, a solenoid arranged in the housing, a pin movable by the solenoid, a closing member movable by the movement of the pin, a second housing part connected to the housing and arranged so as to surround the closing member in the closed position of the valve. The second housing part has an opening in its lateral surface and has a radially encircling sealing surface at its end facing away from the housing, in that the second housing part has a sealing seat against which the closing member bears in the closed state of the valve.

### CROSS REFERENCE TO RELATED APPLICATIONS

This is a U.S. national stage of application No. PCT/EP2017/082871, filed on Dec. 14, 2017. Priority is claimed on German Application No. DE102016226080.4, filed Dec. 22, 2016, the content of which is incorporated herein by reference.

### BACKGROUND OF THE INVENTION

### 1. Field of the Invention

The invention relates to a valve having a housing, a solenoid arranged in the housing, a pin movable by the solenoid, a closing member connected to the pin, and a second housing part connected to the housing and arranged to surround the closing member in the closed position of the valve.

### 2. Description of the Prior Art

Such valves are used, inter alia, as a diverter valve on a turbocharger in motor vehicle to open up a bypass to a suction side in overrun operation, and are thus known. To prevent excessive deceleration of the turbocharger and to ensure a fast launch, fast opening and closing of the valve is an essential prerequisite. For this purpose, it is known to use as closing member a piston which, in the closed state, rests on a valve seat. The valve seat is formed by the housing of the turbocharger on which the valve is flange-mounted. In addition, the axially displaceable piston must be sealed against the housing. For this purpose, it is known to arrange a V-shaped seal in the housing, the limbs of which bear in each case against the housing and against the lateral surface of the piston. The sealing action is achieved by a preload of the two limbs. It is disadvantageous here that the sealing lip, bearing against the piston, of one limb is subjected to friction owing to the piston movement during the opening and closing, resulting in increased wear. Such valves therefore exhibit undesired leakage, which increases over the service life.

### SUMMARY OF THE INVENTION

One aspect of the invention is a valve with improved sealing function, which is intended in particular to exhibit considerably reduced leakage over its service life.

According to one aspect of the invention, the second housing part an opening in its lateral surface and has a radially encircling sealing surface at its end facing away from the housing, in that the second housing part has a sealing seat against which the closing member bears in a closed state of the valve.

In a simple embodiment, the closing member is fixedly connected to the pin. Here, the pin guides the closing member during the opening and closing, such that, with the movement of the pin, an equally defined movement of the closing member occurs.

In one advantageous embodiment, additional components for connecting or fixing the closing member to the pin can be avoided if the closing member is directly connected to the pin. The connection may be of non-positively locking form, in particular by a pressing-on action, positively locking form, in particular by a detent connection, or cohesive form, in particular by welding.

In another advantageous embodiment, the closing member is connected via a holder to the pin. This has the advantage that the closing member is adapted, in terms of form and material, exclusively to its function, whereas the connection to the pin and thus to the movement of the closing member is realized exclusively via the holder, and the latter is accordingly adapted to this function.

A further advantageous embodiment is that the pin has a first driver that moves the closing member into an open position. As a result of the movement of the pin owing to the solenoid, the pin is moved when the solenoid is electrically energized. In the electrically deenergized state of the solenoid, the pin is held in an initial position, or is moved into an initial position if the pin is not in said initial position, by a spring. This function of the spring can be advantageously used for the movement of the closing member.

Additional reliability with regard to the movement of the closing member and the fixing of the closing member in a closed position is achieved in that the pin has a second driver that holds the closing member in a closed position. The holding in the closed position requires a movement of the closing member into the closed position by the second driver at least before a partial distance of the closing movement of the closing member has been covered. Here, the second driver assists the movement of the closing member by the pressure prevailing in the line.

The loading of the closing member can be reduced by means of the drivers if the two drivers are spaced apart axially so that only one driver is in contact with the closing member.

The arrangement of spaced-apart drivers can, in a particularly advantageous embodiment, be utilized for permitting easier opening of the valve. For this purpose, at least one bore, preferably up to four bores and in particular up to eight bores, is/are arranged in the closing member such that the driver that holds the closing member in the closed position covers the bores owing to its greater outer diameter. During the opening of the valve, the pin moves, and the driver opens up the bores, whilst the other driver has not yet reached the closing member. This allows a partial flow to flow through the bores into the valve and reduce the pressure difference on both sides of the closing member. With the reduced pressure difference, easier opening is possible. This in turn allows the use of a less powerful solenoid, which results in a particularly inexpensive valve. If such a solenoid can be designed with smaller dimensions, valuable structural space can be saved in this way.

To achieve a good and reliable seal even in an aggressive environment, forming the closing member from polytetrafluoroethylene (PTFE) has been found to be advantageous. In this way, a dimensionally stable closing member, which in particular exhibits little friction with regard to jamming, can be provided. However, a very good sealing action is also achieved with seals composed of ethylene propylene diene monomer (EPDM) or polyphthalamide (PPA).

In another advantageous embodiment, the closing member is formed to overlap at least the sealing seat of the second housing part. The overlap may be, for example, of stepped, continuous, or preferably conical, form. It is also conceivable for the overlapping form to also be realized at least with respect to one of the drivers, in particular the driver that holds the closing member in the closed position. The overlapping form has the advantage that abrasion and wear of the sealing surfaces on the closing member or the other components do not affect the closing function, so that the valve according to the invention can perform its function without impairments over its service life.

The sealing seat on the second housing part can be realized particularly easily if the second housing part is composed of plastic and the sealing seat is formed integrally with the second housing part. This embodiment has the advantage that the design of the sealing seat can be configured in targeted fashion within wide limits. Furthermore, the sealing seat can be produced particularly easily with the production of the second housing part, in particular by injection molding.

A throughflow from one line to the other line is achieved by the corresponding arrangement of the second housing part in the lines. A leakage through the second housing part is prevented according to an advantageous embodiment in that the sealing seat of the second housing part is a separate component which is connected to the second housing part.

A good sealing action is achieved if the radially encircling sealing surface on the second housing part is formed by a seal, preferably composed of PTFE or EPDM, which is connected to the housing part.

### BRIEF DESCRIPTION OF THE DRAWINGS

The invention will be described in more detail on the basis of an exemplary embodiment. In the figures:

FIG. 1 is a sectional illustration of the valve according to the prior art;

FIGS. 2 and 3 are an enlarged illustration of a valve according to the invention in the region of the closing member; and

FIG. 4 is the closing member.

### DETAILED DESCRIPTION OF THE PRESENTLY PREFERRED EMBODIMENTS

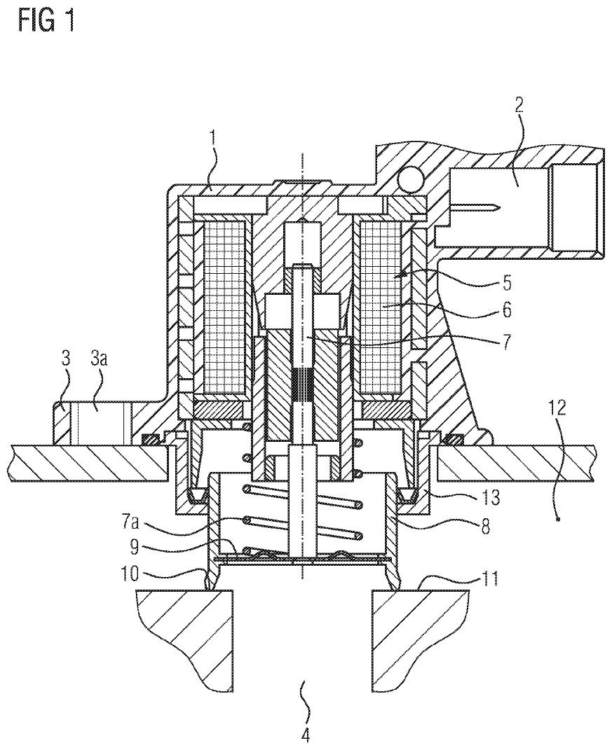

FIG. 1 shows the valve comprising a housing 1 with an integrally molded socket 2 for electrical connection of the valve. The housing 1 furthermore has an integrally formed flange 3 and three bores 3a, by which the housing 1 is flange-mounted on a turbocharger (not illustrated) in the region of a bypass line 4. In the installed position shown, the flange 3 is adjoined by a second housing part 13. In the housing 1, there is arranged a solenoid 5 with a coil 6 and a metal pin 7. The metal pin 7 is connected to a pot-shaped piston 8, which, at the circumference of its base 9, has an axially projecting annular sealing surface 10. In the closed position shown, the sealing surface 10 bears against the valve seat 11 to close off the bypass line 4, so that no medium can flow from the line 4 into the line 12. Here, a spring 7a pushes the piston 8 in the direction of the valve seat 11. The force generated by the spring 7a is counteracted by the force acting on the base 9 owing to the pressure in the line 12.

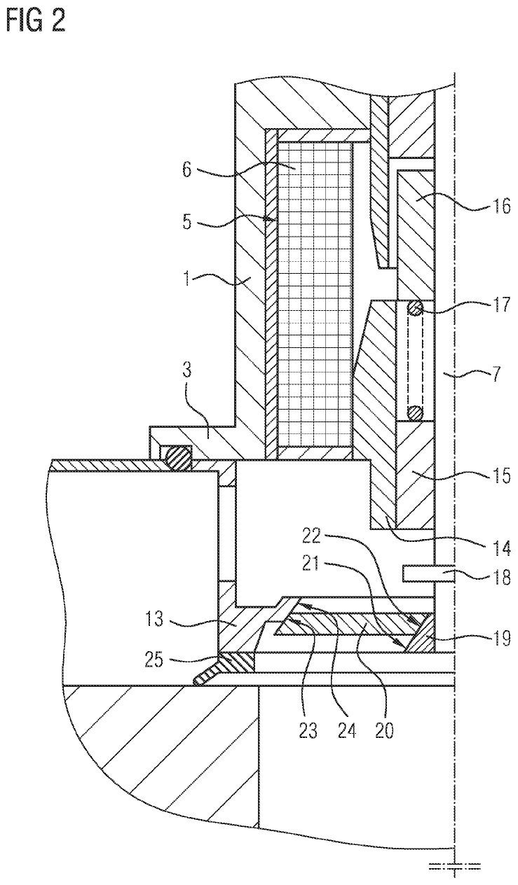

FIG. 2 shows a valve according to one aspect of the invention having the housing 1 with the solenoid 5 in a closed position. The solenoid 5 has a lower stator 14 in which a lower sleeve 15 for guiding the metal pin 7 is fixedly arranged. The pin 7 is equipped, in its upper region, with an armature 16 fixedly arranged on the pin 7. A coil spring 17 is provided between the armature 16 and the lower sleeve 15. Outside the solenoid 5, a first driver 18 is arranged on the pin 7. At its free end, the pin 7 has a second driver 19. The two drivers 18, 19 are spaced apart to such an extent that the closing member 20 situated between the two drivers 18, 19 can always only come into contact with one driver 19, 18. While the first driver 18 has a cylindrical shape, the second driver 19 has a conical lateral surface 21.

In the position shown, the solenoid 5 is electrically deenergized. The coil spring 16 pushes against the lower sleeve 15 and pushes the armature 16 and thus the pin 7 upward. As a result, the second driver 19 bears against the closing member 20, wherein the driver 19 is held in this position by the spring 17. The closing member 20 composed of PTFE has the form of a perforated disk with a parallelogram-shaped cross-sectional area. Thus, the closing member 20 likewise has conical lateral surfaces, wherein the inner lateral surface 22 is oriented oppositely to the lateral surface 21 of the driver 19. This leads to an overlap of the two lateral surfaces 22, 21, which allows a particularly good sealing action. The outer lateral surface 23 of the closing member 20 bears against a sealing seat 24 of the second housing part 13. The sealing seat 24 is integrally formed on the second housing part 13 composed of plastic, and has a sealing surface corresponding to the closing member 20. The second housing part 13 has, at its end averted from the housing 1, a further seal 25 composed of EPDM, which separates the lines 4, 12 from one another.

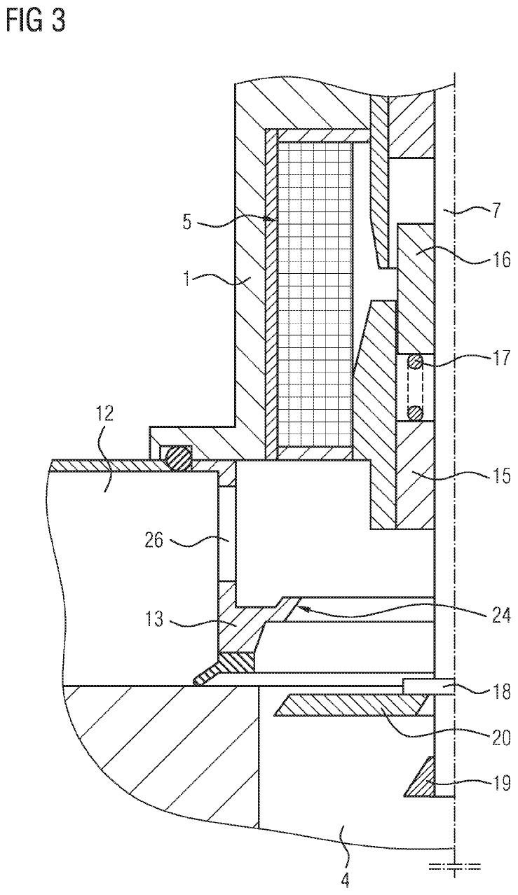

FIG. 3 shows the valve according to one aspect of the invention in the electrically energized state. The armature 16 is pulled downward and the coil spring 17 is compressed. In this movement, the first driver 18 comes into contact with the closing member 20 and pushes it downward, whereby said closing member moves away from the sealing seat 24 of the second housing part 13. Through the opening that is thus opened up, a gas flow from line 4 can now flow through an opening 26 in the lateral surface of the second housing part 13 into the line 12.

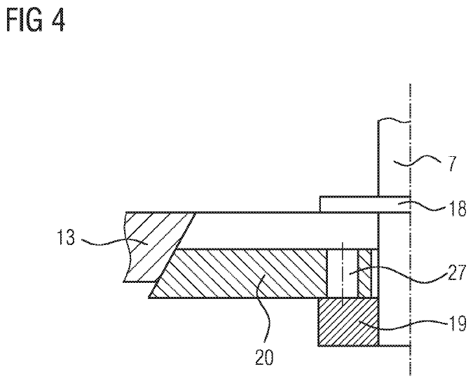

The closing member in FIG. 4 has 4 bores 27 situated radially at the inside, which are arranged so that the second driver 18 has a larger outer diameter and thereby covers the bores 27 in the closed position. During the opening of the valve, the pin 7 moves downward, whereby the second driver 18 opens up the bores 27 before the first driver 18 makes contact with the closing member 20. A partial flow can thus already flow from the line 4 into the valve via the bores 27. As a result, the pressure in the second housing part 13 increases, which leads to a reduction in the pressure difference between the line 4 and the interior of the second housing part 13. The reduction of the pressure difference allows easier opening of the valve.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A valve comprising:
a housing;
a solenoid arranged in the housing;
a pin movable by the solenoid;
a closing member movable by a movement of the pin;
a second housing part connected to the housing and arranged to surround the closing member in a closed position of the valve, wherein the second housing part has an opening defined in its lateral surface and has a radially encircling sealing surface at its end facing away from the housing; and
a sealing seat of the second housing part against which the closing member bears in a closed state of the valve.

14. The valve as claimed in claim 13, wherein the closing member is fixedly connected to the pin.

15. The valve as claimed in claim 13, wherein the closing member is directly connected to the pin.

16. The valve as claimed in claim 13, wherein the closing member is connected to the pin via a holder.

17. The valve as claimed in claim 13, wherein the pin has a first driver that moves the closing member into an open position.

18. The valve as claimed in claim 17, wherein the pin has a second driver that holds the closing member in the closed position.

19. The valve as claimed in claim 18, wherein the first driver and the second driver are axially spaced apart so that only one of the first driver and the second driver is in contact with the closing member.

20. The valve as claimed in claim 13, wherein the closing member is composed of PTFE.

21. The valve as claimed in claim 13, wherein the closing member overlaps at least the sealing seat of the second housing part.

22. The valve as claimed in claim 13, wherein the second housing part is composed of plastic and the sealing seat is formed integrally with the second housing part.

23. The valve as claimed in claim 13, wherein the sealing seat is a separate component that is connected to the second housing part.

24. The valve as claimed in claim 13, wherein a radially encircling sealing surface on the second housing part is formed by a seal connected to the second housing part.

25. The valve as claimed in claim 24, wherein the seal is composed of one of PTFE and EPDM.
